(19) United States
(12) Patent Application Publication
(10) Pub. No.: US 2026/0257135 A1
(43) Pub. Date: Sep. 3, 2026

(54) SENTIMENT ANALYSIS FOR ENGAGEMENT PREDICTION

(71) Applicant: Sony Interactive Entertainment Inc., Tokyo (JP)

(72) Inventor: Sarah Anne Karp, San Mateo, CA (US)

(73) Assignee: Sony Interactive Entertainment Inc., Tokyo (JP)

(21) Appl. No.: 19/067,673

(22) Filed: Feb. 28, 2025

(51) Int. Cl. A63F 13/63; A63F 13/5375; A63F 13/79; G06F 40/20

(52) U.S. Cl. CPC A63F 13/63; A63F 13/5375; A63F 13/79; G06F 40/20

(57) ABSTRACT

Systems and methods for executing a sentiment analyzer in a game include executing, by a system comprising a processor and a memory, the game, receiving, by the system, a plurality of benchmarks associated with the game, determining, by the system, that a user is engaging with the game, determining, by the system, that the user is approaching at least one of the plurality of benchmarks, launching the sentiment analyzer in the game, gathering, via the sentiment analyzer, one or more inputs associated with the user, extracting, by the sentiment analyzer, sentiment information from the one or more inputs associated with the user during a time period that the user is engaging with the game, and outputting, prior to the user reaching the at least one of the plurality of benchmarks, a notification to the user based at least in part on the sentiment information.

### BACKGROUND

The video game industry has expanded significantly such that users have virtually infinite options for video games and other media types for interaction. Example gaming platforms may be the Sony Playstation®, Sony Playstation2® (PS2), Sony Playstation3® (PS3), Sony Playstation3® (PS4), Sony Playstation3® (PS5), etc., each of which is sold in the form of a game console. As is well known, the game console is designed to connect to a monitor (usually a television) and enable user interaction through handheld controllers. The game console is designed with specialized processing hardware, including a CPU, a graphics synthesizer for processing intensive graphics operations, a vector unit for performing geometry transformations, and other glue hardware, firmware, and software. Online gaming is also possible, where a user can interactively play against or with other users over the Internet. Other gaming platforms may include Playstation® Portal and Playstation® VR2. Today's game console is not used just to play games, but are used as a computing device that can access the Internet to search for content, browse for multimedia downloads, shop online music, videos or movies, participate in multiplayer games, enter virtual words, etc. Thus, a community of users is accessing online media, and this community of users has powerful computing devices and versatile interfaces.

Users on a gaming or other multimedia platform have practically infinite amounts of content to choose from. Users often spend some amount of time playing a game or watching a movie before realizing that they are not enjoying the content. This can be a frustrating experience for a user who has limited time to spend on these activities.

Embodiments address these and other problems, individually or collectively.

### SUMMARY

Embodiments of the present invention provide methods, systems, and computer programs for analyzing user sentiment information associated with a game that the user is interacting with. Embodiments of the present disclosure evaluate whether a user is likely to enjoy the game if they continue to play the game and embodiments described herein generate and output notifications to the user based at least in part on gathered sentiment information, from the user and/or other users, from the game the user is currently interacting with and/or games the user has previously interacted with, sentiment information derived from other applications such as social media applications, in-game interactions, etc. Accordingly, embodiments of the present disclosure enable users to make informed decisions about whether to continue interacting with a game based on predicted sentiment information. The user therefore wastes less time interacting with games they are not enjoying and will not enjoy. Embodiments of the present disclosure enhance the system's ability to quickly and efficiently provide recommendations to the user that may result in longer play time and therefore more opportunities to interact with the user.

According to one embodiment, a method for executing a sentiment analyzer in a game includes executing, by a system comprising a processor and a memory, the game, receiving, by the system, a plurality of benchmarks associated with the game, determining, by the system, that a user is engaging with the game, determining, by the system, that the user is approaching at least one of the plurality of benchmarks, launching the sentiment analyzer in the game, gathering, via the sentiment analyzer, one or more inputs associated with the user, extracting, by the sentiment analyzer, sentiment information from the one or more inputs associated with the user during a time period that the user is engaging with the game, and outputting, prior to the user reaching the at least one of the plurality of benchmarks, a notification to the user based at least in part on the sentiment information.

The method may include various optional embodiments. The sentiment analyzer may include a machine learning (ML) model to analyze input based on past sentiment information of the user in other games or past sentiment information of other users in this game. The ML model may be trained with past sentiment information of the user in other games or past sentiment information of other users in this game. The method may further include generating, via the ML model, predicted sentiment information for the user for a remaining time period within the game, generating, a visual representation of the sentiment information and predicted sentiment information, and outputting to the user, the visual representation. The notification may be a recommendation to the user to take an action affecting their engagement with the game. The notification may be a query requesting feedback from the user at a predetermined time period in the game. The method may further include, in response to the user's feedback, modifying at least one feature of the game for the user. The method may further include, in response to the user's feedback, modifying the visual representation of the sentiment information and the predicted sentiment information. The method may further include aggregating user feedback for a game developer to modify the game for other users based at least in part on the user feedback. The method may further include aggregating past sentiment information of the user in other games or past sentiment information of other users in this game. The one or more inputs may include chat information, facial recognition data, time data associated with the user engaging with the game, social media information, biometric data, and audio data.

According to another embodiment, a system includes one or more storage media storing instructions and one or more processors configured to execute the instructions causing the system to perform operations including executing, by the system, a game, receiving, by the system, a plurality of benchmarks associated with the game, determining, by the system, that a user is engaging with the game, determining, by the system, that the user is approaching at least one of the plurality of benchmarks, launching a sentiment analyzer in the game, gathering, via the sentiment analyzer, one or more inputs associated with the user, extracting, by the sentiment analyzer, sentiment information from the one or more inputs associated with the user during a time period that the user is engaging with the game, and outputting, prior to the user reaching the at least one of the plurality of benchmarks, a notification to the user based at least in part on the sentiment information.

The system may further include various optional embodiments. The sentiment analyzer may include a machine learning (ML) model to analyze input based on past sentiment information of the user in other games or past sentiment information of other users in this game. The operations may further include generating, via the ML model, predicted sentiment information for the user for a remaining time period within the game, generating, a visual representation of the sentiment information and predicted sentiment information, and outputting to the user, the visual representation. The notification may be a recommendation to the user to take an action affecting their engagement with the game. The notification may be a query requesting feedback from the user at a predetermined time period in the game. The operations may further include, in response to the user's feedback, modifying at least one feature of the game for the user. The operations may further include, in response to the user's feedback, modifying the visual representation of the sentiment information and the predicted sentiment information. The one or more inputs may include chat information, facial recognition data, time data associated with the user engaging with the game, social media information, biometric data, and audio data.

According to another embodiment, one or more non-transitory computer-readable storage media store instructions that, upon execution by one or more processors of a system, cause the system to execute a game, receive a plurality of benchmarks associated with the game, determine that a user is engaging with the game, determine that the user is approaching at least one of the plurality of benchmarks, launch a sentiment analyzer in the game, gather, via the sentiment analyzer, one or more inputs associated with the user, extract, by the sentiment analyzer, sentiment information from the one or more inputs associated with the user during a time period that the user is engaging with the game, and output, prior to the user reaching the at least one of the plurality of benchmarks, a notification to the user based at least in part on the sentiment information.

### BRIEF DESCRIPTION OF THE DRAWINGS

Features, embodiments, and advantages of the present disclosure are better understood when the following Detailed Description is read with reference to the accompanying drawings.

FIG. 1 illustrates a computer system, according to embodiments of the present disclosure.

FIG. 2 illustrates an example of a game environment, according to some embodiments of the present disclosure.

FIG. 3 illustrates an embodiment of a method of executing a sentiment analyzer in a game using a machine learning (ML) module to provide a user with customized notifications based on user sentiment information, according to embodiments of the present disclosure.

FIG. 4 is a flowchart of a method for executing a sentiment analyzer in a game, according to embodiments of the present disclosure.

FIG. 5 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure provide systems and methods for analyzing and predicting user sentiment information. A machine learning (ML) model may be used to analyze inputs associated with a user and extract sentiment information from the inputs. Based on these inputs, the ML model and the sentiment analyzer may output notifications to the user associated with benchmarks for informing the user of predicted sentiment. A user may decide to continue playing or end the game play session based on the predicted sentiment. A gaming system and game environment for executing the sentiment analyzer according to embodiments of the present disclosure are further described herein.

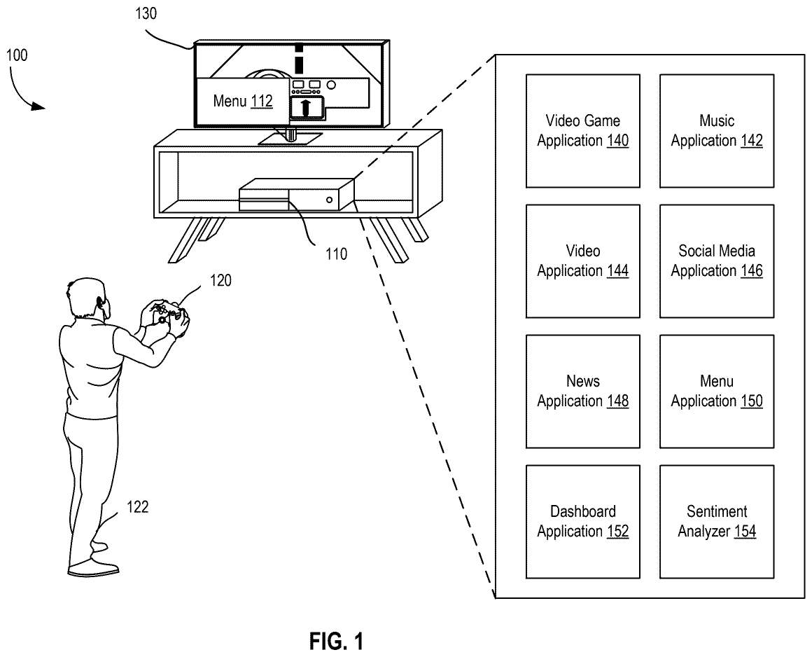

FIG. 1 illustrates a computer system, according to an embodiment of the present disclosure. As illustrated, the computer system 100 includes a video game console 110, a video game controller 120, and a display 130. Although not shown, the computer system may also include a backend system, such as a set of cloud servers, that is communicatively coupled with the video game console 110. The video game console 110 is communicatively coupled with the video game controller 120 (e.g., over a wireless network) and with the display 130 (e.g., over a communications bus). A user 122 operates the video game controller 120 to interact with the video game console 110. These interactions may include playing a video game presented on the display 130, interacting with a menu 112 presented on the display 130, and interacting with other applications of the video game console 110 (e.g., with media applications to stream media from an online content source or to play a media file from the local storage of the video game console 110).

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110 including video game application 140, music application 142, video application 144, social media application 146, and news application 148. A video game application, such as video game application 140, generally represents a computer application executable to present video game content, receive user interaction with the video game content, and accordingly update the video game content. A media application, such as music application 142, video application 144, social media application 146, and news application 148, generally represents a computer application executable to present media content including audio, video, and/or other media types, receive user interaction with the media content, and accordingly update the media content. The media content can be streamed from a remote content source or can be presented form local storage of the video game console 110. Further, other applications can be likewise included in the video game console 110, such as a chat application. The availability of a video game application, media application, and/or other type of computer application to the user 122 via the video game console 110 can depend on a user identifier of the user 122 (e.g., upon a login to the video game console 110, the availability of the computer applications can depend on the user identifier used in the login). In addition, the video game console 110 includes a menu application 150, a dashboard application 152, and a sentiment analyzer 154. The menu application 150 can present a home user interface (UI) in a GUI of the display 130. The dashboard application 152 can present an arrangement of interactive UI widgets in a dashboard page on the GUI.

The video game controller 120 is an example of an input device. The video game controller 120 may allow the user 122 to interact with one or more GUIs presented by the video game consol 110 on the display 130. For example, using one or more directional control inputs (e.g., a joystick and/or a directional pad) the user can navigate to and within various menus, dashboards, and UI elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

Upon an execution of the video game application 140 by the video game console 110, a rendering process of the video game console 110 presents video game content (e.g., illustrated as a car race video game content) on the display 130. Upon user input from the video game controller 120 (e.g., a user push of a particular key or button), the rendering process also presents the menu 112. Additionally, or alternatively, the menu 112 may be presented as an initial landing page in response to a user powering-on the video game console 110 and/or waking the video game consol 110 from a suspended state. Depending on the user input, the menu 112 corresponds to the home UI page, a landing page, or the like. The menu 112 can be presented in a layer over the video game content.

Upon the presentation of the menu 112, the user control changes from the video game application 140 to the menu application 150. Upon receiving a user input from the video game controller 120 requesting interactions with the menu 112, an underlying application (e.g., the menu application 150, the dashboard application 152, or the sentiment analyzer 154 as applicable) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user control changes from the underlying application to the video game application 140.

The dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. Widgets may be presented with application information and/or dynamic content presented with the widget in a media library. For example, the dashboard application 152 may generate and/or present widgets associated with media applications, system applications and/or services, video game applications, or the like.

The dashboard application 152 may be executed via multiple avenues of ingress. For example, the dashboard application 152 may be executed by a pre-defined user interaction (e.g., via controller 120, a voice command from the user 122, activating and/or powering-on the video game consol 110 etc.) and/or by navigating one or more menus and/or sub-menus of the video game console 110 (e.g., menu 112).

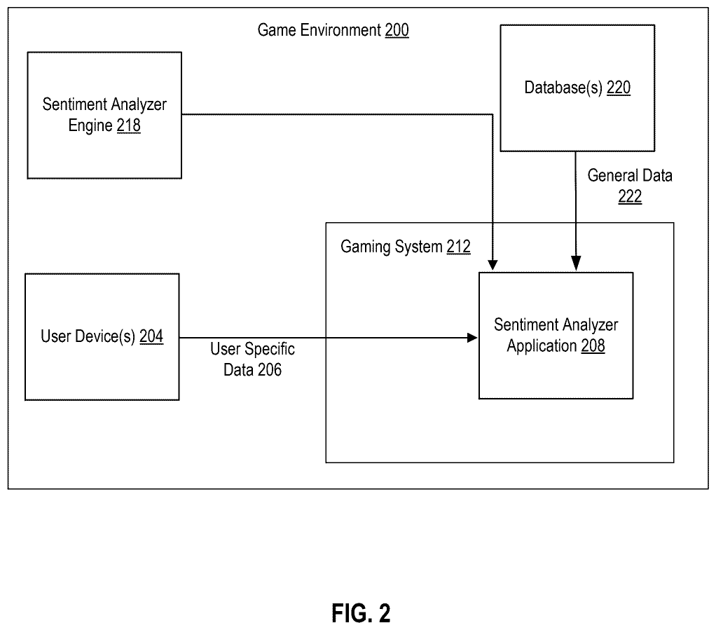

According to various embodiments, and as described in further detail below, the sentiment analyzer 154 may be executed in a game (e.g., in a game environment) for receiving and analyzing user sentiment information. User sentiment information associated with a game they are currently engaged with, in addition to past user sentiment information associated with the same game and/or other games, may be used to update the game, generate recommendations to the user, etc. According to various embodiments, the sentiment analyzer 154 is a local instance of the application and processing of inputs to the application occurs in a cloud-based environment, such as game environment 200 as described with respect to FIG. 2. In other embodiments, processing for the sentiment analyzer 154 may be performed locally and/or via the cloud-based environment.

Although FIG. 1 illustrates that the different applications are executed on the video game console 110, the embodiments of the present disclosure are not limited as such. Instead, the applications can be executed on the backend system (e.g., the cloud servers) and/or their execution can be distributed between the video game console 110 and the backend system.

FIG. 2 illustrates an example of a game environment 200, according to some embodiments of the present disclosure. The game environment 200 may include at least a user device(s) 204, a gaming system 212, a database(s) 220, and sentiment analyzer engine 218. The gaming system 212 can receive user specific data 206 from the user device 204. The gaming system 212 may also receive general data 222 from a database 220, to be described in further detail below. The sentiment analyzer engine 218 may be executed on a cloud-based server or the like. Each user device 204 runs a local instance of a sentiment analyzer application 208, such as the sentiment analyzer 154 as described with respect to FIG. 1.

According to various embodiments, a database 220 can include general data 222 that supports system operations, game mechanism, and user engagement. For example, the database 220 can include game environment data, such as in-game world states, weather conditions, and dynamically changing elements like non-playable character (NPC) behavior or item spawn locations. The database 220 can include general user engagement metrics, such as average time spent on different game modes, popular levels or maps, and frequency of activity across various game features. The general user engagement metrics can be used to identify patterns in user behavior, such as which modes are most engaging or which areas of the game require balancing or improvement. The database 220 can also include game performance metrics, such as frame rates, load times, crash log, and latency statistics, which are critical for optimizing the technical aspects of the game and ensuring smooth gameplay. The database 220 can include inventory data, such as available in-game items, skins, or vehicles, as well as data on how frequently these items are used or unlocked by players. The database 220 can include event participation data, such as the number of players joining seasonal or time-limited events, their completion rates, and the outcomes of these events. The database 220 can also include leaderboard ranking and information for competitive or cooperative play, such as player skill ratings, connection quality, and regional-based preferences.

The database 220 can include user-specific data such as personal information, account details, subscription tiers, playtime statistics, friend lists, purchase history, and feedback provided by the user. The database 220 can also include user profile data such as gaming preferences like favorite genre, difficulty levels, unlocked achievements, skill level, in-game behavior, and avatar customization. The database 220 can further include comprehensive data such as game-specific data, content data, usage metrics, content recommendation data, community and social data, system data, and cross-platform data.

The database 220 can be embedded directly within the gaming console or system and stored on a local hard drive or solid-state drive. The gaming system 212 can communicate with the database 220 using an application programing interface (API) or file system integrations. Additionally, the one or more databases 220 can be hosted externally, such as on cloud servers. Cloud databased can communicate with the gaming system via internet protocols, such as RESTful APIs or WebSocket connections, providing real-time updates and synchronization. Additionally, hybrid setups are possible, where certain data (e.g., critical game files) is stored locally, while dynamic data (e.g., live game stats) resides in the cloud. The database 220 can also be integrated into third party services, such as gaming networks (e.g., PlayStation Network or Xbox Live). These external databases communicate with the gaming system through secure authentication protocols and encrypted data streams to ensure privacy and integrity. Furthermore, certain gaming systems may utilize edge computing, where smaller, distributed databases are located closer to the end user to reduce latency for high-performance scenarios like competitive gaming. The gaming system 212 can interact with the databases 220 through middleware or game engines which provide structured pathways for database queries and responses.

According to various embodiments, the ML model of the of the sentiment analyzer engine 218 is trained to be capable of processing natural language descriptions. The natural language training input may be part of a plurality of inputs. The natural language input can be processed by the ML model for generating outputs such as sentiment information. To guide the training process, the natural language input may include ground truth information, which can act as a reference dataset containing predefined sentiment information. The ground truth information may be further validated against the outputs generated by the ML model, according to various embodiments, for finding discrepancies and refining the ML model. The ML model may be iteratively refined via a feedback loop and additional training cycles.

According to various embodiments of the present disclosure, the ML model of the sentiment analyzer engine 218 may receive feedback from the user device 204 for updating and training the ML model. For example, in response to the user feedback, the ML model may modify the predicted user preferences. For example, when user gameplay diverges from typical gameplay behavior, the ML model may recognize this change in behavior and adapt to accommodate new behaviors. Furthermore, the ML model may generate inquiries to determine whether the predicted user preferences are still accurate or whether the predicted user preferences need to be updated. The ML model may be updated in response to feedback and/or in response to identifying a change in user behavior. The ML model may be updated continuously and/or at predetermined intervals or as new inputs are received for training the ML model. Once the training process achieves a satisfactory level of accuracy and consistency, the ML model may be executed as part of the sentiment analyzer engine 218.

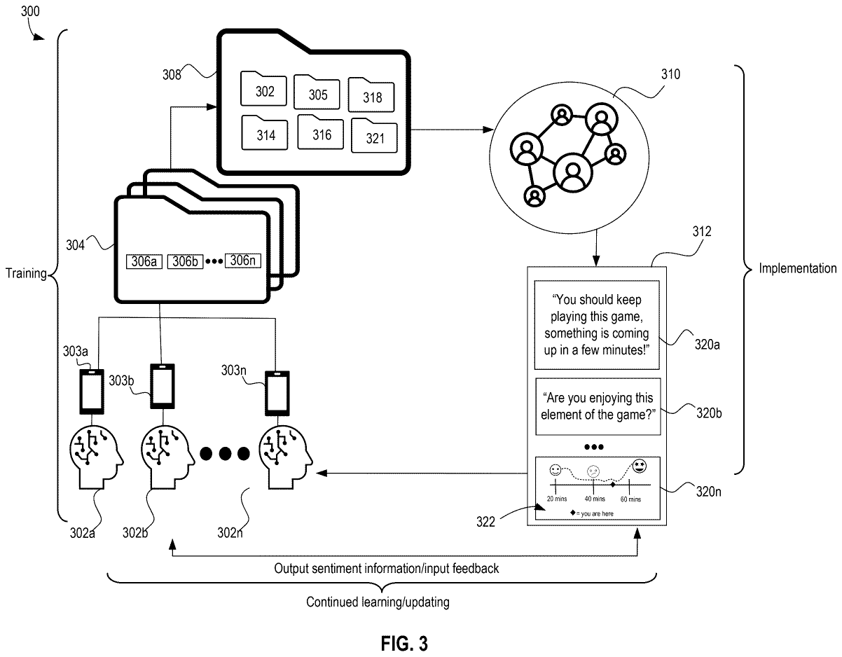

FIG. 3 illustrates an embodiment of a method of executing a sentiment analyzer in a game environment 300 using a machine learning (ML) module (e.g., a sentiment analyzer engine 310) to provide a user 302 with customized notifications based on user sentiment information. The sentiment analyzer engine 310 may be executed on a cloud-based server or the like. Each user 302 may be associated with a user device 303 that runs a local instance of a sentiment analyzer application, such as the sentiment analyzer 154 as described with respect to FIG. 1. According to the shown embodiment, the method may include a plurality of users 302 playing a game 304. The games 304 played by the users 302 may vary and include various genres such as action games, fighting games, role playing games, shooting games, sports games, etc. For each game 304, a plurality of benchmarks 306 associated with the game 304 are received as inputs 308 in the game environment 300 for the sentiment analyzer engine 310. A benchmark 306 may refer to a point in time or a time period of interest within the game 304. For example, a benchmark 306 may include a beginning of a level, an end of a level, an achievement within the game, a challenge within the game, a change in the plot of the game, etc. Benchmarks 306 may be predetermined by a game developer according to some embodiments. For example, the plurality of benchmarks 306 can be pre-defined events or turning points in the game. In another embodiment, a developer of the game may provide the sentiment analyzer engine 310 with additional data to assist with the selection of benchmarks 306 that may be indicative of what to include in the menu 312. In other embodiments, the sentiment analyzer engine 310 processes user data and determines whether a benchmark 306 exists at a certain point in time or within a time period. For example, the sentiment analyzer engine 310 may analyze data associated with a plurality of users 302 that indicates players who have played 4 hours move from a first level to a second level within a game and therefore the 4-hour mark is a benchmark 306.

In various embodiments, the game environment 300 determines that at least one user 302 is engaging with the game 304. The system may further determine that determining, by the system, that the user 302 is approaching at least one of the plurality of benchmarks 306. For example, the system may include one or more timers (not shown) that track various activities within the game. The system, in response to one of the one or more timers approaching a predetermined threshold, may determine that the user 302 is approaching a benchmark 306. Approaching a benchmark 306 may be defined, according to at least some embodiments, as within 5 minutes of gameplay before reaching the benchmark 306, within 10 minutes of gameplay before reaching the benchmark 306, within 15 minutes of gameplay before reaching the benchmark 306, etc., or any increment of time preceding the benchmark 306.

According to various embodiments, a system executing the game environment 300 and the game 304 may launch the sentiment analyzer engine 310 in the game 304. In various embodiments, the game environment 300 includes a sentiment analyzer engine 310 that implements one or more machine learning operations. The one or more machine learning operations ingest one or more inputs 308 to determine which notifications and/or queries to include in the menu 312 for a particular user. In some embodiments, these inputs 308 may include the user information 305 associated with each of the users 302 such as a profile associated with each user 302, the plurality of benchmarks 306 for each game 304, corresponding metadata 314 associated with each of the plurality of benchmarks 306 (e.g., such as metadata 314 referring to timestamps, type, or the like), user feedback 316, etc. In various embodiments, the one or more inputs may be gathered from social media applications 318. Other inputs 321 may include biometric information such as facial recognition technology implemented into the gaming environment such as through a user console or the like. Other inputs may include any combination of chat information, facial recognition data, time data associated with the user engaging with the game, social media information, biometric data, audio data, etc. In one embodiment, the sentiment analyzer engine 310 can process the inputs 308 to identify user sentiment information. The sentiment information can be further processed to identify specific notifications to be output to the user 302.

In at least some embodiments, the sentiment analyzer engine 310 includes a ML model configured to analyze input 308 based on past sentiment information of the user 302 in the current game and/or in other games. The sentiment analyzer engine 310 may further analyze inputs 308 including past sentiment information of other users 302. The other users 302 may have the similar skill set as the user 302 (e.g., overlapping skills in a skill set as the user 302). In various embodiments, the ML model of the sentiment analyzer engine 310 is trained on any of the inputs 308, games 304, user information associated with the users, etc. In various embodiments, the sentiment analyzer engine 310 is trained with past sentiment of the user 302 in the current game and/or in other games. For example, the sentiment analyzer engine 310 may be trained on user data including rates of hours played, a number of players who played a game and how long they played the game, stopping points for players playing the game, etc.

In some embodiments, the sentiment analyzer engine 310 gathers one or more inputs 308 associated with the user 302. The one or more inputs 308 may include information, facial recognition data, time data associated with the user engaging with the game, social media information, biometric data, audio data, etc. The sentiment analyzer engine 310 extracts sentiment information from the one or more inputs 308 associated with the user 302 during a time period that the user 302 is engaging with the game 304. According to various embodiments, the sentiment analyzer engine 310 may use one or more machine learning models, classifiers, and rules to predict user sentiment information. In accordance with another embodiment, the sentiment analyzer engine 310 may be configured to determine which descriptive sentiment information in that game that is common among other users. In some embodiments, various inputs 308 may include a weighting factor to help determine which specific notifications 320 associated with sentiment to select for a user's menu 312. In one embodiment, the sentiment analyzer engine 310 may assign a higher weighting factor to those inputs 308 which are provided by the user 302 such as the user feedback 316.

In various embodiments, the sentiment analyzer engine 310 outputs, prior to the user 302 reaching the at least one of the plurality of benchmarks 306, a notification 320 to the user 302 based at least in part on the sentiment information. In some embodiments, the sentiment analyzer engine 310 may be configured to process the profile associated with the user 302 to help generate the notifications 320 output to the user 302. The user profile may include user attributes such as gender, age, gaming experience, gameplay history, gaming skill level, preferences, interests, disinterests, etc. For example, the sentiment analyzer engine 310 may process user feedback 316 (e.g., which may have been prompted from prior notifications 320) to determine user sentiment at a period of time within the game. In some embodiments, the user feedback 316 may include user selections, user non-selections, and/or user comments. The user feedback 316 may further help capture additional characteristics of the user 302 since the user feedback 316 is provided directly from the user 302.

The notifications 320 may include various optional embodiments. In some embodiments, the notification 320 may be a recommendation to the user 302 to take an action affecting their engagement with the game 304. For example, the notification 320 may recommend that the user stop playing the game, continue playing the game, continue playing the game for a certain period of time, the user change gameplay in anticipation of a benchmark 306, etc. In further embodiments, the notification 320 is a query requesting feedback from the user 302 at a predetermined time period in the game. For example, the query may request user feedback as to whether the user is enjoying the game, do they want to continue to play the game, are they planning to meet a certain goal before they stop playing for the session, etc.

The sentiment analyzer engine 310 may further generate, via the ML model, predicted sentiment information for the user 302 for a remaining time period within the game. For example, the sentiment analyzer engine 310 may predict that a user 302 will enjoy the next 15 minutes of the game 304 and may encourage the user 302 to keep playing the game 304. A notification 320 may be output to the user 302 suggesting that the user 302 continues to play the game, especially if the sentiment analyzer engine 310 determines that an upcoming benchmark 306 may alter the user's 302 gameplay and sentiment.

In some embodiments, the sentiment analyzer engine 310 may generate a visual representation of the sentiment information and predicted sentiment information. For example, embodiments of the present disclosure characterize the game 304 from a time domain and provide outputs to the user 302 that includes data about the way the user and/or other users use their time within the game. Further embodiments of the present disclosure aim to provide the user 302 with a roadmap of the game and what to expect. The visual representation may be in the form of the menu 312 including notifications 320 to the user. Accordingly, the menu 312 may be output to the user 302.

In various embodiments, the visual representation includes a timeline 322 or other graphical representation (e.g., such as a heat map, a graph, etc.) including information indicative of the user's 302 position within the game 304 based on time of gameplay, level, number of achievements, etc., and information indicative of past sentiment information and/or predicted sentiment information generated by the sentiment analyzer engine 310. A timeline 322 may be helpful to illustrate to the user 302 any upcoming benchmarks 306 and their predicted response to them (e.g., is the user 302 predicted to enjoy the next benchmark, is the user 302 going to be bored by the next benchmark 306 and should save it for another day, should the user 302 continue playing to meet a certain goal within the game 304, etc.). In some embodiments, in response to the user's feedback, the sentiment analyzer engine 310 may modify the visual representation of the sentiment information and the predicted sentiment information.

According to various embodiments, the ML model of the of the sentiment analyzer engine 310 is trained to be capable of processing natural language descriptions. The natural language training input may be part of the plurality of inputs 308. The natural language input can be processed by the ML model for generating outputs, which can include a resource to be used to further generate the menu 312 of notifications 320. To guide the training process, the natural language input may include ground truth information, which can act as a reference dataset containing predefined sentiment information. The ground truth information may be further validated against the outputs generated by the ML model, according to various embodiments, for finding discrepancies and refining the ML model. The ML model may be iteratively refined via a feedback loop and additional training cycles.

According to various embodiments of the present disclosure, the ML model of the sentiment analyzer engine 310 may receive feedback from the user 302 for updating and training the ML model. For example, in response to the user feedback, the ML model may modify the predicted user preferences. For example, when user gameplay diverges from typical gameplay behavior, the ML model may recognize this change in behavior and adapt to accommodate new behaviors. Furthermore, the ML model may generate inquiries to determine whether the predicted user preferences are still accurate or whether the predicted user preferences need to be updated. The ML model may be updated in response to feedback and/or in response to identifying a change in user behavior. The ML model may be updated continuously and/or at predetermined intervals or as new inputs are received for training the ML model. Once the training process achieves a satisfactory level of accuracy and consistency, the ML model may be executed as part of the sentiment analyzer engine 310.

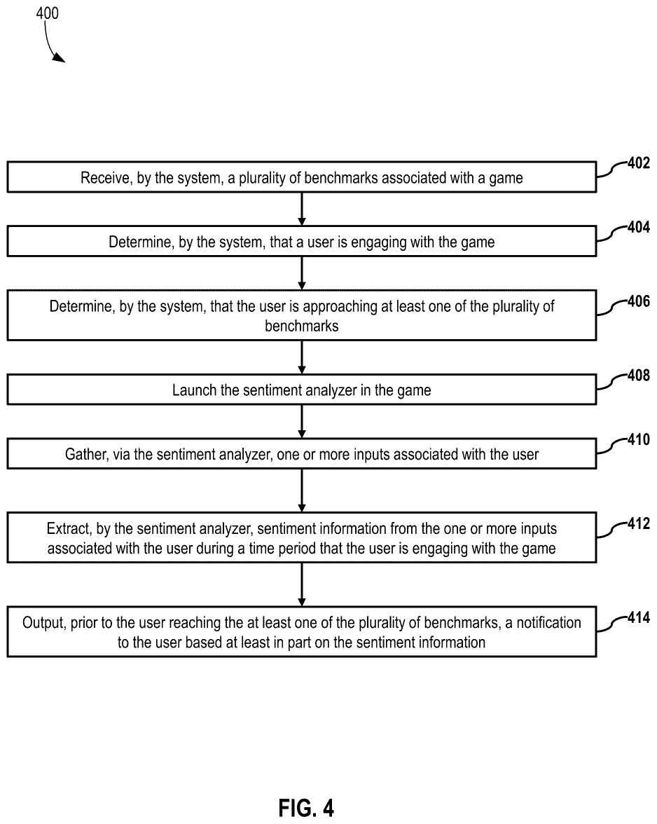

FIG. 4 is a flowchart of a method for executing a sentiment analyzer in a game. Process 400 may, for example, be performed in whole or in part by the system 100, the game environment 200, the game environment of FIGS. 1-3, and/or any combination thereof. Block 402 includes executing, by a system comprising a processor and a memory, a game. A game may be interchangeably referred to as a video game herein and may refer to any game played by electronically manipulating images produced by a computer program on a display.

Block 404 includes receiving, by the system, a plurality of benchmarks associated with the game. A benchmark may refer to a point in time or a time period of interest within the game. For example, a benchmark may include a beginning of a level, an end of a level, an achievement within the game, a challenge within the game, a change in the plot of the game, etc. Benchmarks may be predetermined by a game developer according to some embodiments. For example, the plurality of benchmarks can be pre-defined events or turning points in the game.

Block 406 includes determining, by the system, that a user is engaging with the game. For example, the system may determine that a user has started the game and is progressing through the game. Determining that the user is engaging with the game may be performed according to techniques known in the art.

Block 408 includes determining, by the system, that the user is approaching at least one of the plurality of benchmarks. For example, the system may include one or more timers or other tracking tools that track various activities within the game. A timer may indicate how long a player has played the game or a certain portion of the game. Predetermined benchmarks may be associated with a point in time within the game or time periods within the game. Accordingly, the system may use time of play to determine whether a user is approaching a benchmark, according to various embodiments. The system, in response to one of the one or more timers approaching a predetermined threshold, may determine that the user is approaching a benchmark. Approaching a benchmark may be defined, according to at least some embodiments, as within 5 minutes of gameplay before reaching the benchmark, within 10 minutes of gameplay before reaching the benchmark, within 15 minutes of gameplay before reaching the benchmark, etc., or any increment of time preceding the benchmark. In other embodiments, approaching a benchmark may refer to a relative position of the user within the game. For example, a user may be determined to be approaching a benchmark if the user completes a penultimate challenge within a level.

Block 410 includes launching the sentiment analyzer in the game. A sentiment analyzer (e.g., a sentiment analyzer engine) according to the present disclosure implements one or more machine learning operations or models. The one or more machine learning operations ingest one or more inputs to determine sentiment information. Sentiment information may include information indicate of a user's view of or attitude toward the game and/or events within the game. Sentiment information may refer to a user's emotion or feeling at various time period within the game. For example, the sentiment information may be indicative of the user enjoying the game, the user being bored with the game, the user being frustrated with the game, etc. The sentiment analyzer engine may be further configured to generate predicted sentiment information based at least in part on the present sentiment information, to be described in further detail below. Embodiments of the present disclosure provide users with a characterization of the game with respect to time such that they can determine whether or not they want to keep playing the game.

Block 412 includes gathering, via the sentiment analyzer, one or more inputs associated with the user. In some embodiments, these inputs may include user information associated with each of a plurality of users such as a profile associated with each user, the plurality of benchmarks for the game, a plurality of benchmarks for other games, corresponding metadata (e.g., such as metadata referring to timestamps, type, or the like), user feedback, etc. In various embodiments, the one or more inputs may be gathered from social media applications. For example, a chat feature within a game may be categorized as a social media application. The sentiment analyzer may process information from the chat feature and determine that the user is enjoying the game (e.g., based on the words in the chat, the emojis used, etc.). Inputs derived from the chat may also be used to generate suggestions to the user in addition to the recommendation of whether to keep playing the game. For example, exemplary tools (e.g., weapons) within the game may be discussed in the chat and the sentiment analyzer may confirm via a notification to the user that the user should continue to play using the mentioned tool. Other inputs may include biometric information such as facial recognition technology implemented into the gaming environment such as through a user console or the like. In some embodiments, video game controllers may be equipped with biometric sensors where heart rate and/or breath rate information may be further input into the sentiment analyzer to determine user sentiment information.

Block 414 includes extracting, by the sentiment analyzer, sentiment information from the one or more inputs associated with the user during a time period that the user is engaging with the game. The sentiment analyzer may include a ML model configured to analyze input based on past sentiment information of the user in other games and/or past sentiment information of other users in this game. The one or more inputs may be extracted by the sentiment analyzer continuously throughout the game or only during predetermined time periods. The entire length of the game may be a time period according to some embodiments. In at least some embodiments, one or more inputs are extracted that are associated with the one or more benchmarks. For example, one or more inputs may be extracted as the user is approaching a benchmark and/or once the user is at the benchmark and engaging with the benchmark (e.g., starting the new level, completing the challenge, etc.). Sentiment information from the one or more inputs at these times may be particularly indicative of the user's sentiment. The ML model may be trained with past sentiment information of the user in other games and/or past sentiment information of other users in this game. According to some embodiments, these inputs may have a higher weight than other inputs when generating a visual representation of the user sentiment information, to be described in further detail below.

Block 406 includes outputting, prior to the user reaching the at least one of the plurality of benchmarks, a notification to the user based at least in part on the sentiment information. In some embodiments, the notification may be a recommendation to the user to take an action affecting their engagement with the game. For example, the notification may recommend that the user stop playing the game, continue playing the game, continue playing the game for a certain period of time, the user change gameplay in anticipation of a benchmark, etc. In further embodiments, the notification is a query requesting feedback from the user at a predetermined time period in the game. For example, the query may request user feedback as to whether the user is enjoying the game, do they want to continue to play the game, are they planning to meet a certain goal before they stop playing for the session, etc.

In some embodiments, process 400 may further include in response to the user's feedback, modifying at least one feature of the game for the user. For example, the sentiment analyzer may perform real-time analysis of the game and user sentiments to improve features as users play the game. In other embodiments, the analysis is aggregated and sent to a game developer who may make changes to features within the game based at least in part on user sentiment. Embodiments of the present disclosure advantageously provide an accurate summary of user experiences within the game. The game developer may modify game feature based on user preferences that are determined from the user sentiment information.

In some embodiments, process 400 may further include generating, via the ML model, predicted sentiment information for the user for a remaining time period within the game (e.g., predicted user sentiment information), generating, a visual representation of the sentiment information and predicted sentiment information, and outputting to the user, the visual representation. For example, embodiments of the present disclosure provide the user with a roadmap of the game and what to expect. The visual representation may be in the form of the menu including notifications to the user. In other embodiments, the visual representation includes a timeline or other graphical representation (e.g., such as a heat map, a graph, etc.) including information indicative of the user's position within the game based on time of gameplay, level, number of achievements, etc., and information indicative of past sentiment information and/or predicted sentiment information generated by the sentiment analyzer. For example, a heat map may visualize the state of the game during different points such that a concentrated red area is indicative of a challenge, and a concentrated green area is indicative of a non-challenging part of the game. Inputs derived from the chat application may be further used by the sentiment analyzer to validate time points within the game for generating a timeline to output to the user. A timeline may illustrate upcoming benchmarks and a user's predicted response to them (e.g., is the user predicted to enjoy the next benchmark, is the user going to be bored by the next benchmark and should save it for another day, should the user continue playing to meet a certain goal within the game, etc.). In some embodiments, in response to the user's feedback, the sentiment analyzer may modify the visual representation of the sentiment information and the predicted sentiment information.

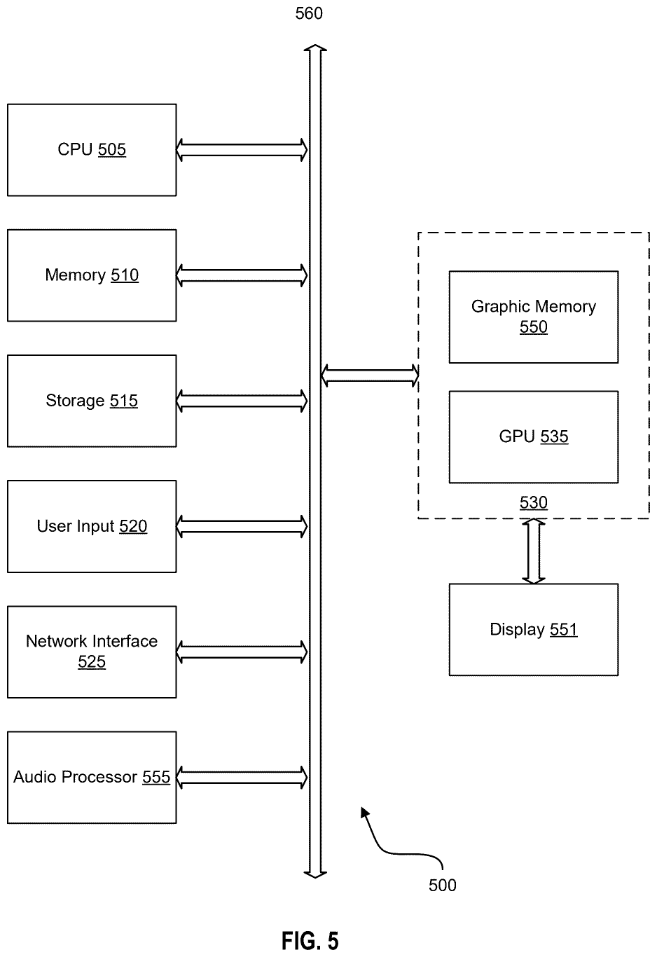

FIG. 5 illustrates an example of a hardware system suitable for implementing a computer system, according to embodiments of the present disclosure. The computer system 500 represents, for example, a video game system, a backend set of servers, or other types of a computer system. The computer system 500 includes a central processing unit (CPU) 505 for running software applications and optionally an operating system. The CPU 505 may be made up of one or more homogeneous or heterogeneous processing cores. Memory 510 stores applications and data for use by the CPU 505. Storage 515 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 520 communicate user inputs from one or more users to the computer system 500, examples of which may include keyboards, mice, thumbsticks, touch pads, touch screens, still or video cameras, and/or microphones. Network interface 525 allows the computer system 500 to communicate with other computer systems via an electronic communications network and may include wired or wireless communication over local area networks and wide area networks such as the Internet. An audio processor 555 is adapted to generate analog or digital audio output from instructions and/or data provided by the CPU 505, memory 510, and/or storage 515. The components of computer system 500, including the CPU 505, memory 510, data storage 515, user input devices 520, network interface 525, and audio processor 555 are connected via one or more data buses 560.

A graphics subsystem 530 is further connected with the data bus 560 and the components of the computer system 500. The graphics subsystem 530 includes a graphics processing unit (GPU) 535 and graphics memory 550. The graphics memory 550 includes a display memory (e.g., a frame buffer) used for storing pixel data for each pixel of an output image. The graphics memory 550 can be integrated in the same device as the GPU 535, connected as a separate device with the GPU 535, and/or implemented within the memory 510. Pixel data can be provided to the graphics memory 550 directly from the CPU 505. Alternatively, the CPU 505 provides the GPU 535 with data and/or instructions defining the desired output images, from which the GPU 535 generates the pixel data of one or more output images. The data and/or instructions defining the desired output images can be stored in the memory 510 and/or graphics memory 550. In an embodiment, the GPU 535 includes 3D rendering capabilities for generating pixel data for output images from instructions and data defining the geometry, lighting, shading, texturing, motion, and/or camera parameters for a scene. The GPU 535 can further include one or more programmable execution units capable of executing shader programs.

The graphics subsystem 530 periodically outputs pixel data for an image from the graphics memory 550 to be displayed on the display device 551. The display device 551 can be any device capable of displaying visual information in response to a signal from the computer system 500, including CRT, LCD, plasma, and OLED displays. The computer system 500 can provide the display device 551 with an analog or digital signal.

In accordance with various embodiments, the CPU 505 is one or more general-purpose microprocessors having one or more processing cores. Further embodiments can be implemented using one or more CPUs 505 with microprocessor architectures specifically adapted for highly parallel and computationally intensive applications, such as media and interactive entertainment applications.

Although various embodiments of the present disclosure are described with respect to a game environment, embodiments described herein may be applied to other media types such as video (e.g., movies, shows, etc.), audio, visual, etc. For example, embodiments of the present disclosure may be applied to a user watching a movie. A sentiment analyzer may be used to determine the user's sentiment information during the movie and to further predict the user's sentiment as the movie progresses. For example, the sentiment analyzer may determine that the user does not enjoy the movie thus far and further predicts that the user will not enjoy the rest of the movie. Accordingly, the sentiment analyzer may generate and output a notification to the user recommending that the user stop the movie and/or watch a different movie instead. A similar analysis may be performed for a user listening to a music album or watching a television series where the sentiment analyzer gathers sentiment information and outputs recommendations based at least in part on predicted user sentiment information.

Embodiments of the present disclosure enable a game environment to analyze user data to predict sentiment information and provides recommendations to a user in real-time. These embodiments offer significant advantages over existing systems delivering suggestions in real time, dramatically reducing delays compared to traditional methods. The user can make informed decisions about whether to continue toward a benchmark or to engage with different content for a better experience. Embodiments of the present disclosure provide a system that ensures that users are presented with options as the user approaches these benchmarks.

The sentiment analyzer further verifies the users' sentiment throughout the engagement with the content. Accordingly, processing power is saved by prioritizing content that the user will actually engage with (e.g., finish, pay attention to, etc.). Accordingly, any associated advertising may be more efficiently delivered to the user thereby providing higher rates of success. The sentiment analyzer supplements and enhances the user experience within the game environment and particularly within the game executed within the game environment. By optimizing data processing and reducing delays, the system ensures a seamless and dynamic user experience while maintaining high performance and scalability.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for executing a sentiment analyzer in a game, the method comprising:
executing, by a system comprising a processor and a memory, the game;
receiving, by the system, a plurality of benchmarks associated with the game;
determining, by the system, that a user is engaging with the game;
determining, by the system, that the user is approaching at least one of the plurality of benchmarks;
launching the sentiment analyzer in the game;
gathering, via the sentiment analyzer, one or more inputs associated with the user;
extracting, by the sentiment analyzer, sentiment information from the one or more inputs associated with the user during a time period that the user is engaging with the game; and
outputting, prior to the user reaching the at least one of the plurality of benchmarks, a notification to the user based at least in part on the sentiment information.

2. The method of claim 1, wherein the sentiment analyzer comprises a machine learning (ML) model configured to analyze input based on past sentiment information of the user in other games or past sentiment information of other users in this game.

3. The method of claim 2, wherein the ML model is trained with past sentiment information of the user in other games or past sentiment information of other users in this game.

4. The method of claim 2, further comprising:
generating, via the ML model, predicted sentiment information for the user for a remaining time period within the game;
generating, a visual representation of the sentiment information and predicted sentiment information; and
outputting to the user, the visual representation.

5. The method of claim 1, wherein the notification is a recommendation to the user to take an action affecting their engagement with the game.

6. The method of claim 1, wherein the notification is a query requesting feedback from the user at a predetermined time period in the game.

7. The method of claim 4, further comprising, in response to the user's feedback, modifying at least one feature of the game for the user.

8. The method of claim 4, further comprising, in response to the user's feedback, modifying the visual representation of the sentiment information and the predicted sentiment information.

9. The method of claim 7, further comprising, aggregating user feedback for a game developer to modify the game for other users based at least in part on the user feedback.

10. The method of claim 1, further comprising, aggregating past sentiment information of the user in other games or past sentiment information of other users in this game.

11. The method of claim 1, wherein the one or more inputs comprises chat information, facial recognition data, time data associated with the user engaging with the game, social media information, biometric data, and audio data.

12. A system comprising:
one or more storage media storing instructions; and
one or more processors configured to execute the instructions causing the system to perform operations comprising:
executing, by the system, a game;
receiving, by the system, a plurality of benchmarks associated with the game;
determining, by the system, that a user is engaging with the game;
determining, by the system, that the user is approaching at least one of the plurality of benchmarks;
launching a sentiment analyzer in the game;
gathering, via the sentiment analyzer, one or more inputs associated with the user;
extracting, by the sentiment analyzer, sentiment information from the one or more inputs associated with the user during a time period that the user is engaging with the game; and
outputting, prior to the user reaching the at least one of the plurality of benchmarks, a notification to the user based at least in part on the sentiment information.

13. The system of claim 12, wherein the sentiment analyzer comprises a machine learning (ML) model configured to analyze input based on past sentiment information of the user in other games or past sentiment information of other users in this game.

14. The system of claim 13, further comprising:
generating, via the ML model, predicted sentiment information for the user for a remaining time period within the game;
generating, a visual representation of the sentiment information and predicted sentiment information; and
outputting to the user, the visual representation.

15. The system of claim 12, wherein the notification is a recommendation to the user to take an action affecting their engagement with the game.

16. The system of claim 12, wherein the notification is a query requesting feedback from the user at a predetermined time period in the game.

17. The system of claim 16, further comprising, in response to the user's feedback, modifying at least one feature of the game for the user.

18. The system of claim 16, further comprising, in response to the user's feedback, modifying the visual representation of the sentiment information and the predicted sentiment information.

19. The system of claim 12, wherein the one or more inputs comprises chat information, facial recognition data, time data associated with the user engaging with the game, social media information, biometric data, and audio data.

20. One or more non-transitory computer-readable storage media storing instructions that, upon execution by one or more processors of a system, cause the system to:
execute a game;
receive a plurality of benchmarks associated with the game;
determine that a user is engaging with the game;
determine that the user is approaching at least one of the plurality of benchmarks;
launch a sentiment analyzer in the game;
gather, via the sentiment analyzer, one or more inputs associated with the user;
extract, by the sentiment analyzer, sentiment information from the one or more inputs associated with the user during a time period that the user is engaging with the game; and
output, prior to the user reaching the at least one of the plurality of benchmarks, a notification to the user based at least in part on the sentiment information.
